(19) United States
(12) Patent Application Publication
(10) Pub. No.: US 2024/0351952 A1
(43) Pub. Date: Oct. 24, 2024

(54) PROCESS FOR THE PREPARATION OF A ZIRCONIA GRANULATE

(71) Applicant: Ivoclar Vivadent AG, Schaan (LI)

(72) Inventors: Alexander ENGELS, Feldkirch (AT); Bettina SCHWENDINGER, Feldkirch (AT)

(21) Appl. No.: 18/686,181

(22) PCT Filed: Aug. 9, 2022
(86) PCT No.: PCT/EP2022/072371

§ 371 Date: Feb. 23, 2024

(30) Foreign Application Priority Data
Aug. 25, 2021 (EP) 21193112.6

(51) Int. Cl. C04B 35/486; A61C 5/77; A61C 13/00; C04B 35/626; C04B 35/632

(52) U.S. Cl. CPC C04B 35/486; A61C 5/77; A61C 13/0022; C04B 35/6264; C04B 35/62655; C04B 35/62695; C04B 35/632; C04B 2235/3246; C04B 2235/5427; C04B 2235/5445; C04B 2235/5454; C04B 2235/604; C04B 2235/612; C04B 2235/6567

(57) ABSTRACT

The invention relates to a process for the preparation of a zirconia granulate from a zirconia powder and to the use of the granulate for the preparation of dental blanks and dental restorations.

The present invention relates to a process for the preparation of a zirconia granulate having advantageous processing properties.

Due to their favourable properties, zirconia ceramics are used in a wide variety of applications, e.g. as a solid electrolyte in fuel cells and for the manufacture of dental restorations.

Zirconia ceramic products are generally prepared from a powdered zirconia starting material. Typically, this involves shaping a zirconia powder into the desired product and sintering. Preferred processes are (i) axial pressing or cold isostatic pressing (CIP) followed by conventional sintering, (ii) slip casting followed by conventional sintering, and (iii) hot pressing (HP) or hot isostatic pressing (HIP).

It is desirable for all the processes mentioned that the zirconia starting material used has advantageous processing properties. In particular, the starting material should be flowable and should not contain any undesirable compounds which have to be removed again in the course of the manufacture of zirconia products.

Processes for improving the processability, such as the flowability, of zirconia powders are known.

The flowability can usually be improved by adding a flow aid, such as a fumed silica (e.g. AEROSIL® from Evonik Industries AG).

DE 10 250 712 A1 also describes the possibility of further improving the flowability of the powder by a surface treatment, such as silanisation, of the silica used as a flow aid.

The processability of a zirconia powder can also be improved by first processing it into a granular material. In conventional processes, such as in roller compacting, granulation is achieved by applying external pressure to compact the powder.

In addition, conventional processes require the use of binders such as organic polymers to reinforce the cohesion of the powder particles. EP 3 659 574 contains an overview of common binders for use in the manufacture of zirconia ceramic products.

However, the binder usually has to be removed in the further manufacturing process of a ceramic product by a heat treatment, the so-called debinding step.

In view of the shortcomings described above, the invention is based on the problem of providing a process by which a zirconia granulate with advantageous processing properties can be prepared.

According to the invention, this problem is solved by the process for the preparation of a zirconia granulate according to claims 1 to 11. A further object of the invention is the zirconia granulate according to claim 12 and the use of the zirconia granulate according to claims 13 to 18. The invention is also directed to the process for the preparation of a blank for dental purposes according to claim 19 and to the process for the preparation of a dental restoration according to claim 20.

The process for the preparation of a zirconia granulate according to the invention is characterized in that a zirconia powder is agglomerated by build-up granulation to give the granulate.

It was surprisingly found that the zirconia granulate prepared according to the invention has advantageous properties which allow for a particularly fast and simple further processing of the granulate. In particular, the zirconia granulate prepared by the process according to the invention is characterized by very good pressability. The properties of the granulate allow, for example, for the use of automated presses and make it possible to omit a debinding step, thus considerably reducing the overall duration of the sintering process. Furthermore, the process according to the invention is also particularly cost-efficient, since the advantageous processing properties result in reduced loss of material. Furthermore, the process according to the invention allows for the use of particularly inexpensive zirconia starting materials which contain little or no additives.

For the purposes of the invention, the term “granulate” refers to particulates which consist of a plurality of clustered, i.e. agglomerated, particles, such as powder particles.

The granulate is generally flowable. A “flowable” granulate may also be referred to as a pourable granulate and is, for the purposes of the invention, a granulate which can be transported in a free-flowing manner under the influence of gravity and without the application of additional forces. It is preferred that the granulate according to the invention, when placed in a sealed measuring funnel made plastic, of in particular polyoxymethylene homopolymer (Delrin® from Dupont), can flow out of the funnel solely due to gravity after opening the funnel opening, wherein the funnel has an inclination of 40° and an outlet opening with a diameter of 8 mm.

For the purposes of the invention, the term “build-up granulation” refers to processes in which, in particular, rolling movements or particle impacts of the powder or small particulates of clustered powder particles lead to the formation of larger particulates of clustered powder particles. In contrast to this, processes in which a granulate is formed by pressing the powder particles, such as in roller compacting, are not understood as build-up granulation. Spray drying processes likewise do not involve a build-up granulation within the meaning of the present invention. This is because agglomeration in spray drying processes is not based on rolling movements or particle impacts of the powder or small particulates, but on the evaporation or vaporization of a solvent.

A zirconia powder is used as the starting material for agglomeration.

It is preferred that the powder has a primary particle size of 20 to 500 nm, preferably 80 to 300 nm, in particular 200 to 400 nm, particularly preferably 250 to 350 nm, measured as d₅₀ value and based on the volume of the particles. The particle size is determined in particular by the method of static laser diffraction (SLS) according to ISO 13320:2009, e.g. using a particle analyzer LA-960 of the company Horiba, or dynamic light diffraction (DLS) according to ISO 22412:2017, e.g. using a particle analyzer Nano-flex of the company Colloid Metrix. The primary particle size can also be determined by scanning electron microscopy.

The zirconia powder is in particular zirconia based on polycrystalline tetragonal zirconia (TZP). Preferred is zirconia stabilized with Y₂O₃, La₂O₃, CeO₂, MgO and/or CaO and in particular stabilized with 2 to 14 mol-%, preferably 2 to 10 mol-% and particularly preferably 2 to 8 mol-% of these oxides, based on the amount of zirconia.

In a preferred embodiment, the zirconia comprises 0 to 7 mol-%, preferably 0 to 5 mol-% and particularly preferably 0.1 to 5 mol-% Y₂O₃.

The zirconia powder can also be a mixture of zirconia powders with different composition, which in particular lead to a different colouring and/or translucency in the product finally manufactured from the granulate, such as a dental restoration. Thus, by means of a mixture of differently coloured zirconia powders, the desired colour for the manufactured product can be achieved easily and in a targeted manner. The degree of translucency can be controlled in particular by the amount of yttrium oxide in the zirconia powders used.

In another preferred embodiment, prior to agglomeration a suspension of the zirconia powder is prepared and this suspension is dried.

It is preferred that the suspension comprises water, unbranched alcohol, branched alcohol or a mixture thereof, in particular essentially unbranched alcohol, branched alcohol or a mixture thereof, as liquid medium.

Particularly preferably, the unbranched alcohol or the branched alcohol is a compound having the formula CₙH₂ₙ₊₁OH, where n is an integer from 1 to 4.

In a further preferred embodiment, the liquid medium comprises an organic component, preferably in an amount of not more than 4 wt.-%, more preferably not more than 2 wt.-%, even further preferred not more than 0.5 wt.-%, based on the amount of solids in the suspension. In a particularly preferred embodiment, the liquid medium is substantially free of organic components.

In particular, dispersing agents, agents for adjusting the pH value, stabilizing agents and/or defoamers may be used as organic components.

The dispersant serves to avoid the aggregation of suspended particles. The amount of dispersant in the liquid medium is in particular 0.01 to 3 wt.-%, preferably 0.1 to 2 wt.-% and particularly preferably 0.1 to 1 wt.-%, based on the amount of solids in the suspension.

Suitable dispersants are dispersants containing carboxylic acid or carboxylic acid salt, such as the ammonium salt of polymethacrylic acid (Dolapix CE64, Zschimmer & Schwarz Chemie GmbH).

Without the addition of a dispersant, the suspension can typically have a solids content of up to 50 wt.-%. By adding a dispersant to the suspension, higher solids contents, such as up to 85 wt.-%, can usually be obtained.

Suitable agents for adjusting the pH and as stabilizing agents are, in particular, acids and bases, such as carboxylic acids, for example 2-(2-methoxyethoxy)acetic acid and 2-[2-(2-methoxyethoxy)ethoxy]acetic acid, inorganic acids, for example hydrochloric acid and nitric acid, as well as ammonium hydroxide and tetramethylammonium hydroxide. It is preferred that the liquid medium comprises tetramethylammonium hydroxide.

The defoamer serves to prevent air bubbles in the suspension. It is typically used in the liquid medium in an amount of 0.001 to 1 wt.-%, preferably 0.001 to 0.5 wt.-% and particularly preferably 0.001 to 0.1 wt.-%, based on the amount of solids in the suspension. Examples of suitable defoamers are paraffin, silicone oils, alkylpolysiloxanes, higher alcohols, propylene glycol, ethylene oxide-propylene oxide adducts and, in particular, alkylpolyalkylene glycol ethers.

Due to the low proportion of organic components, these can also be burnt out within a short time from a blank which has been obtained from the zirconia granulate prepared according to the invention. This process is usually also referred to as debinding.

The suspension may also contain colouring elements, such as colouring oxides or solutions of colouring salts, in the solids and/or in the liquid medium. The colouring elements may be d- and f-elements of the periodic table of the elements. Preferred colouring elements are Pr, Fe, Tb, Cr, Mn, V, Ti, Nd, Eu, Dy, Er and/or Yb.

In a preferred embodiment, prior to agglomeration the suspension is dried by spray drying or to a dry cake, in particular dried by spray drying.

In spray drying, the suspension is dried by spraying in a heated drying medium.

Drying to a dry cake may be carried out, for example, in drying cabinets or by freeze-drying. In a preferred embodiment, the suspension is dried in a drying cabinet for a duration of 3 to 12 hours, preferably 6 to 10 hours, at a temperature of 50 to 200° C., preferably 100 to 180° C. The drying may also be carried out by means of microwave radiation.

Preferably, the powder has a solids content of at least 99 wt.-%, in particular at least 99.7 wt.-% and particularly preferably at least 99.9 wt.-%. Thus, it is also preferred that the powder, such as a dry cake of the zirconia powder or a powder obtained by spray-drying, has less than 1 wt.-%, in particular less than 0.3 wt.-% and particularly preferably less than 0.1 wt.-% residual moisture.

In a preferred embodiment, the powder is sieved and/or subjected to a vibration treatment before agglomeration, wherein the sieving is preferably carried out through a sieve having a mesh size of 200 to 700 μm, in particular 300 to 600 μm, more preferably 400 to 500 μm and particularly preferably 450 μm. This is to break up or dissolve any powder aggregates that may be present. It is further particularly preferred to carry out the sieving and the vibration treatment simultaneously. Preferably, the vibration treatment with simultaneous sieving is carried out for 10 to 30 min, in particular 15 to 20 min, at 10 to 50 Hz, in particular at 25 to 45 Hz.

It may be advantageous, for example, to first mechanically break up a dry cake into coarse pieces, e.g. smaller than about 10 cm, if necessary, and then subject it to a vibration treatment with simultaneous sieving.

The powders provided according to the above embodiments, and optionally sieved and/or subjected to a vibration treatment, are suitable to be agglomerated to give a granulate.

In a preferred embodiment, agglomeration is carried out without the addition and/or without the removal of a liquid. The term “removal” of liquid refers to any process for reducing the liquid content, such as evaporation or vaporization.

It is particularly preferred that no liquid is added and no liquid is removed during agglomeration. In this embodiment, the liquid content remains essentially constant during agglomeration.

In a further preferred embodiment, the powder is agglomerated dry. This means that the powder used for agglomeration is substantially dry and that agglomeration is also carried out without the addition of a liquid. Such conditions exist in particular if agglomeration is carried out without the addition of a liquid and, furthermore, a powder having a residual moisture content of less than 1 wt.-%, in particular less than 0.3 wt.-% and particularly preferably less than 0.1 wt.-% residual moisture is used.

It has surprisingly been found that agglomeration can even be effected with very little liquid and even under dry conditions. Therefore, unlike in known processes, it is not necessary to use a powder with a considerable amount of liquid or to add liquid, such as a liquid binder, to the powder during agglomeration.

In a preferred embodiment, the powder comprises organic binder in an amount of 3 wt.-% or less, preferably 1 wt.-% or less, particularly preferably less than 1 wt.-% and more preferably 0.1 wt.-% or less. It is particularly preferred that the powder is substantially free of organic binders.

In another preferred embodiment, organic binder is added to the powder during agglomeration in an amount of 3 wt.-% or less, preferably 1 wt.-% or less, particularly preferably less than 1 wt.-% and more preferably 0.1 wt.-% or less. It is particularly preferred that no organic binder is added during agglomeration.

It was also surprisingly found that the zirconia powder can also be agglomerated with a small amount of binder or even without the use of organic binders to form a granulate that is excellently suitable for various applications and in particular for the preparation of dental restorations.

It is further preferred that agglomeration is carried out by shaking, vibrating, oscillating, acoustically mixing and/or rotating the powder or a powder bed consisting of the powder. Suitable devices are, for example, vibrating sieves, rotating granulation machines (e.g. from Maschinenfabrik Gustav Eirich GmbH & Co KG, Germany), resonant acoustic mixers (e.g. from Resodyn Acoustic Mixers, USA) and pelletizers. In particular, agglomeration is carried out without the use of mixer elements, such as blades or paddles.

In a preferred embodiment, the powder is agglomerated on a sieve, such as a Perflux sieve from Siebtechnik GmbH, wherein the sieve preferably has a mesh size of 30 to 60 μm, in particular 40 to 50 μm, particularly preferably 45 μm. In this way, individual powder particles and small particulates of clustered powder particles can be sorted out through the meshes.

In another preferred embodiment, agglomeration may be carried out on a silicone polymer surface. For example, a sieve may be coated with a silicone polymer in such a way that the meshes are closed and a flat surface is formed. If a closed surface is used, individual powder particles and small particulates of clustered powder particles can also be incorporated into the granulate. A suitable silicone polymer is, for example, Elastosil Vario 40 from Wacker Chemie AG.

It is further preferred that a surface in contact with the powder during agglomeration is non-conductive. It is particularly preferred that none of the surfaces in contact with the powder during agglomeration are conductive. Suitable surfaces comprise, for example, polyurethane-coated metal surfaces.

Preferably, agglomeration is carried out for a duration of 5 to 120 min, in particular 10 to 60 min, particularly preferably 10 to 20 min.

In a preferred embodiment, agglomeration is carried out at a temperature of less than 80° C., in particular less than 50° C. and quite particularly preferably less than 30° C.

It was surprisingly found that a high solids content of the zirconia powder can be beneficial for reducing the time required for agglomeration.

In a preferred embodiment, powders having a solids content of at least 99 wt.-%, preferably at least 99.9 wt.-%, are agglomerated for a duration of in particular 5 to 30 min, preferably 5 to 15 min, at a frequency of in particular 10 to 50 Hz, preferably 25 to 45 Hz. It may be advantageous to select the vibration frequency, optionally depending on the degree of filling of the vibrating sieve, in such a way that dust formation is avoided.

If the powder is sieved and/or subjected to a vibration treatment prior to agglomeration, it may be advantageous for an efficient process to collect the material passing the sieve in a suitable device, such as a vibrating sieve, and agglomerate directly therein.

In a preferred embodiment, the granulate has an average particle size of 10 to 600 μm and in particular 150 to 500 μm, measured as d₅₀ value and based on the volume of the particles.

In another preferred embodiment, the granulate has an average particle size of less than 50 μm, measured as a d₅₀ value and based on the volume of the particles.

In another preferred embodiment, at least 90%, in particular at least 95%, more preferably at least 99%, of the particles of the granulate have a size of 10 to 600 μm, preferably 150 to 500 μm.

It has further been shown that longer agglomeration durations can typically yield larger particles. For example, by using a duration in the range of several hours, particles having a diameter of more than 2 mm can be obtained.

It may further be advantageous to sieve the granulate after agglomeration to obtain a more uniform particle size distribution. For example, particles having a diameter of greater than 600 μm can be separated by sieving.

The invention also relates to a process for the preparation of a blank for dental purposes, in which a zirconia granulate is prepared according to the process of the invention and is then shaped into a blank for dental purposes.

The shaping of the zirconia granulate into a blank for dental purposes can be carried out according to methods known per se.

In a preferred embodiment, shaping the zirconia granulate into a blank for dental purposes comprises placing the zirconia granulate in a mould and then pressing it, in particular uniaxially and/or isostatically. It is particularly preferred that the zirconia granulate is introduced into the mould by means of an air flow.

It is moreover preferred that the blank is subjected to a heat treatment in order to produce a presintered open-porous blank.

In a preferred embodiment, the heat treatment for presintering is carried out at a temperature of 700 to 1200° C., preferably at a temperature of 800 to 1100° C., and for a duration of 5 min to 100 h, in particular 10 min to 12 h and particularly preferably 30 min to 6 h, wherein the term “duration” refers to the holding time of the maximum temperature.

Embodiments which have been described as suitable or preferred in connection with the process for the preparation of a zirconia granulate are also analogously suitable or preferred for the preparation of a blank for dental purposes according to the invention.

The invention also relates to a process for the preparation of a dental restoration, in which a blank for dental purposes is prepared according to the process according to the invention and
(i) the blank is subjected to machining to give the blank the shape of a dental restoration, and
(ii) the blank is sintered by at least one heat treatment.

In a preferred embodiment, the machining comprises milling and/or grinding. It is preferred that the machining is carried out with computer-controlled milling and/or grinding devices. It is particularly preferred that the machining is carried out as part of a CAD/CAM process.

Preferably, in step (i) the blank is given the shape of a bridge, an inlay, an onlay, a crown, a partial crown, an implant, a veneer, a facet or an abutment.

Sintering can be carried out at a temperature of 1050 to 1700° C., in particular 1200 to 1600° C., preferably 1300 to 1550° C., particularly preferably 1350 to 1500° C. The heat treatment for sintering is carried out in particular for a duration of 0 to 240 min, preferably 5 to 180 min, particularly preferably 30 to 120 min, wherein the term “duration” refers to the holding time of the maximum temperature.

Sintering typically serves to finally densify the zirconia and thereby give the dental restoration the excellent mechanical properties. In that case, sintering is usually also referred to as “dense sintering”.

In a preferred embodiment, the density of the blank shaped into the dental restoration after the sintering of step (ii) is more than 5.9 g/cm³, in particular more than 6.00 g/cm³ and particularly preferably more than 6.02 g/cm³.

Embodiments which have been described as suitable or preferred in connection with the process for the preparation of the zirconia granulate and the process for the preparation of a blank for dental purposes are also analogously suitable or preferred for the preparation of a dental restoration according to the invention.

The invention also relates to a flowable zirconia granulate obtainable by the process of the invention as described above.

The zirconia granulate prepared by the process according to the invention typically has a bulk density of 1.1 to 1.5 g/cm³, in particular 1.2 to 1.4 g/cm³. The bulk density can be determined, for example, in accordance with DIN EN ISO 60.

In a preferred embodiment, the zirconia granulate comprises organic binder in an amount of 3 wt.-% or less, preferably 1 wt.-% or less, more preferably 0.1 wt.-% or less. In a particularly preferred embodiment, the zirconia granulate is substantially free of organic binder.

In another preferred embodiment, the zirconia granulate comprises organic components in an amount of 9 wt.-% or less, preferably 4 wt.-% or less, more preferably 1 wt.-% or less. In a particularly preferred embodiment, the zirconia granulate is substantially free of organic components. Zirconia granulate that is substantially free of organic components has the advantage that a debinding step is typically not required during further processing.

In particular, dispersants, pH-adjusting agents, stabilizing agents and/or defoamers, as described above, may be used as organic components.

The zirconia granulate may moreover include a lubricant. The lubricant typically serves to further improve the processability of the granulate, particularly during pressing, by reducing friction between the particles as well as between the particles and the press mould.

Preferred lubricants are stearates, in particular magnesium stearate and ammonium stearate. It is further preferred that the granulate comprises 0.01 to 5 wt.-%, in particular 0.05 to 2 wt.-%, particularly preferably 0.1 to 1 wt.-% lubricant. The lubricant, for e.g. ammonium stearate, can be added to the suspension. It is also possible to add the lubricant, e.g. magnesium stearate, after agglomeration.

Finally, the invention also relates to the use of the zirconia granulate obtainable by the process described above for the preparation of a dental blank or a dental restoration. Typically, the granulate according to the invention is first used to produce a dental blank, which can then in turn be subjected to shaping and densely sintered to prepare a dental restoration.

The granulate according to the invention can advantageously be used to prepare dental blanks or dental restorations therefrom. The advantageous properties of the granulate allow for a particularly simple handling of the zirconia granulate, thereby reducing loss of material and shortening the duration of the process. Unlike in the use of conventional zirconia powders, the granulate according to the invention can be used e.g. in automatic presses.

In a preferred embodiment of the use, the granulate is introduced into a mould by means of an air flow. The direction of the air flow is irrelevant, i.e. the granulate can be sucked or blown into the mould. It is particularly preferred that the mould is a compression mould.

Also preferred is an embodiment in which the granulate is placed in a compression mould and pressed into a blank. The granulate may be pressed into a blank in dry or moist or wet state. Preferably, the granulate is pressed into a blank in dry state.

In a preferred embodiment of the use according to the invention, the pressing is carried out uniaxially at a pressure of 5 to 90 MPa, preferably 10 to 60 MPa, more preferably 10 to 40 MPa.

It may be advantageous to subject the blank to post-compression by cold isostatic pressing, preferably at a pressure of 100 to 600 MPa, more preferably 150 to 500 MPa and particularly preferably 150 to 400 MPa.

It is moreover preferred that the blank is presintered, preferably at a temperature of 600 to 1300° C., in particular 700 to 1200° C., particularly preferably 800 to 1100° C., for a duration of in particular 1 h to 100 h, preferably 6 h to 80 h and particularly preferably 20 h to 40 h.

After presintering, the blank is typically in an open-porous state and can be used to prepare a dental restoration therefrom. In the preparation of the dental restoration, the blank is typically first given the shape of a dental restoration, e.g. in a CAD/CAM process, and the shaped blank is then densely sintered to give a dental restoration.

It is preferred that a blank is given the shape of a dental restoration and the shaped blank is sintered at 1200 to 1600° C., in particular 1300 to 1550° C., particularly preferably 1350 to 1500° C.

It is further preferred that the time for heating the blank from room temperature to the sintering temperature, holding at the sintering temperature and cooling to the final temperature is 120 min or less, preferably 60 min or less, more preferably 40 min or less and particularly preferably 30 min or less. In this context, “final temperature” is understood as a temperature at which the sample can be held in the hand, and it is in particular 15 to 80° C., preferably 25 to 60° C. and particularly preferably about 50° C. “Room temperature” is understood as a temperature of in particular 15 to 30° C., preferably 20 to 25° C. and particularly preferably about 25° C.

In another preferred embodiment of the use according to the invention, the dental restoration is a bridge, an inlay, an onlay, a crown, a partial crown, an implant, a veneer, a facet or an abutment.

The dental restoration obtained after dense sintering can be veneered, polished and/or glazed, if necessary.

By the use according to the invention, dental restorations with very good optical and mechanical properties can be produced.

It has been found that the solids content of the suspension produced to provide the powder can have an effect on the flexural strength of a dental restoration prepared from the granulate. For example, suspensions having a solids content of less than 70 wt.-% can be used to prepare dental restorations having a biaxial flexural strength of greater than 1000 MPa, determined according to ISO 6872:2015.

As the use according to the invention and the processes according to the invention are different aspects of the same invention, the embodiments disclosed in connection with the use according to the invention and their advantages also analogously apply to the processes according to the invention and vice versa.

The invention will be explained in more detail below with reference to examples.

### EXAMPLES

### Example 1: Preparation of a Zirconia Granulate

A zirconia granulate was prepared by the process according to the invention. For this purpose, a suspension having a solids content of 45 wt.-% was first prepared from ethanol and zirconia powder stabilized with 3 mol-% yttria (TZ-3Y-E from Tosoh). The suspension was dried in a drying cabinet for 9 h at 180° C. The resulting dry cake was first coarsely mechanically comminuted and then subjected to a vibration treatment with simultaneous sieving on a sieve having a mesh size of 450 μm for 20 min at 40 Hz.

The powder thus produced was agglomerated without the use of binders by means of a vibration sieve (Perflux sieve from Siebtechnik GmbH) for 20 min at 45 Hz. The vibration sieve was coated with a silicone polymer (Elastosil Vario 40 from Wacker Chemie AG) so that it had a flat, closed surface.

The prepared granulate had an average particle size d₅₀ of about 200 μm, based on the volume of the particles.

### Example 2: Use of the Zirconia Granulate for the Preparation of Dental Test Specimens

The zirconia granulate prepared according to Example 1 was uniaxially pressed at room temperature and a pressure of 50 MPa to form shaped bodies in the form of blocks or discs.

This was followed by post-compression of the shaped bodies by cold isostatic pressing at room temperature and a pressure of 300 MPa.

The obtained shaped bodies were presintered at 1000°° C. for 60 h.

The presintered shaped bodies were machined into the shape of test specimens having a diameter of 12.5±0.5 mm and a thickness of 1.2±0.2 mm. The test specimens were polished and densely sintered at 1550° C.

The test specimens exhibited biaxial flexural strengths of about 1000 MPa, determined according to ISO 6872:2015.

1. A process for the preparation of a zirconia granulate, in which a zirconia powder is agglomerated by build-up granulation to give the granulate.

2. The process according to claim 1, wherein the powder comprises organic binder in an amount of 3 wt.-% or less.

3. The process according to claim 1, wherein the powder has a primary particle size of 20 to 500 nm measured as d₅₀ value and based on the volume of the particles.

4. The process according to claim 1, wherein prior to agglomeration a suspension of a zirconia powder is prepared and this suspension is dried.

5. The process according to claim 4, wherein the suspension comprises water, unbranched alcohol, branched alcohol or a mixture thereof as liquid medium.

6. The process according to claim 4, wherein the suspension is dried by spray drying or to a dry cake.

7. The process according to claim 1, wherein the powder has a solids content of at least 99 wt.-%.

8. The process according to claim 1, wherein the agglomeration is carried out by shaking, vibrating, oscillating, acoustically mixing and/or rotating the powder or a powder bed consisting of the powder.

9. The process according to claim 1, wherein a surface in contact with the powder during agglomeration is non-conductive.

10. The process according to claim 1, wherein the agglomeration is carried out for a duration of 5 to 120 min.

11. The process according to claim 1, wherein the granulate has an average particle size of 10 to 600 μm measured as d₅₀ value and based on the volume of the particles.

12. A zirconia granulate obtainable by the process according to claim 1.

13. A process for using the zirconia granulate according to claim 12 for the preparation of a dental blank or a dental restoration.

14. The process for using the zirconia granulate according to claim 13, wherein the granulate is introduced into a mould by an air flow.

15. The process for using the zirconia granulate according to claim 13, wherein the granulate is placed in a compression mould and pressed into a blank.

16. The process for using the zirconia granulate according to claim 13, wherein the blank is presintered at a temperature of 600 to 1300° C. for a duration of 1 h to 100 h.

17. The process for using the zirconia granulate according to claim 13 for the preparation of a dental restoration, wherein the blank is given the shape of a dental restoration and the shaped blank is sintered at 1200 to 1600° C.

18. The process for using the zirconia granulate according to claim 13, wherein the dental restoration is a bridge, an inlay, an onlay, a crown, a partial crown, an implant, a veneer, a facet or an abutment.

19. A process for the preparation of a blank for dental purposes, in which a zirconia granulate is prepared according to the process of claim 1 and is then shaped into a blank for dental purposes.

20. A process for the preparation of a dental restoration, in which a blank is prepared according to the process according to claim 19 and
(i) the blank is subjected to machining to give the blank the shape of a dental restoration, and
(ii) the blank is sintered by at least one heat treatment.
